(19) United States
(12) Patent Application Publication
(10) Pub. No.: US 2012/0186069 A1
(43) Pub. Date: Jul. 26, 2012

(54) Fan Hand

(76) Inventor: Frank R. Cox, South Point, OH (US)

(21) Appl. No.: 13/355,442

(22) Filed: Jan. 20, 2012

Related U.S. Application Data
(60) Provisional application No. 61/434,944, filed on Jan. 21, 2011.

(51) Int. Cl. B23P 17/04

(52) U.S. Cl. 29/592

(57) ABSTRACT

A method of making a magnetic slab having the steps of placing a personal appendage on a background and outlining the personal appendage on the background. Then scanning the outline into a computer and entering a scanned image into a graphics program that creates a cutting form from the scanned image. The printing of an image on the magnetic slab follows as well as the cutting of the magnetic slab using the cutting form. The personal appendage is a foot or a hand. A magnetic slab has a main portion shaped as a palm integrally connected to a portion as a thumb; other connected portions include an index finger, a middle finger, a ring finger, a pinky so that a scanned image is imprinted on the magnetic slab. A magnetic slab has a portion shaped as a hindfoot, midfoot and forefoot integrally connected and a plurality of forefoot toe portions.

### CROSS REFERENCE TO RELATED APPLICATIONS

This application claims priority from provisional application No. 61/434,944 filed on Jan. 21, 2011.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

(1) Field of the Invention

Relating to improvements in the manufacture of refrigerator magnets.

A refrigerator magnet is a decoration attached to a magnet that is used to post items such as shopping lists, reminders, art or similar such items; they also can serve as as decorations alone. Refrigerator magnets come in a wide variety of shapes and sizes, including thin die cut forms the thickness of heavy card stock, and may have promotion al messages placed on them. Refrigerator magnets are a relatively popular collectable object. In this disclosure, a magnet slab or simply a slab is intended to mean a thin die cut form the thickness of heavy card stock that has a magnetic property; i.e., the most common type of refrigerator magnet.

Fans of famous people, athletes and sports teams, characters and notable figures like to display memorabilia around their house. Typically, this consists of a generic framed picture or article about the famous person. While this does give fans a way to show their admiration, it does not provide any personal connection to the famous person. Additionally, fans are unable to interact with a picture or plaque that is hung on the wall. A more personal and interactive method of paying homage to famous people is needed.

### BRIEF SUMMARY OF THE INVENTION

A method of making a magnetic slab having the steps of placing a personal appendage on a background and outlining the personal appendage on the background. Then scanning the outline into a computer and entering a scanned image into a graphics program that creates a cutting form from the scanned image. The printing of an image on the magnetic slab follows as well as the cutting of the magnetic slab using the cutting form. The personal appendage is a foot or a hand.

A magnetic slab has a main portion shaped as a palm integrally connected to a first portion of the slab shaped as a thumb; and the main portion also integrally connected to a second portion of the slab shaped as an index finger. A third portion of the slab integrally connected to the main portion and shaped as a middle finger. A fourth portion of the slab integrally connected to the main portion and shaped as a ring finger. A fifth portion of the slab integrally connected to the main portion and shaped as a pinky so that a scanned image is imprinted on the magnetic slab. A magnetic slab has a portion shaped as a hindfoot integrally connected with a second portion shaped as a midfoot. A third portion shaped as a forefoot integrally connected with the second portion and a plurality of other portions shaped as toes integrally connected to the forefoot portion.

### BRIEF DESCRIPTION OF THE SEVERAL VIEWS OF THE DRAWINGS

FIG. 1 illustrates various forms of the Fan Hand as described in an embodiment.

FIG. 2 illustrates the process of manufacturing the Fan Hand in an embodiment.

### DETAILED DESCRIPTION OF THE INVENTION

Fan hand is a magnet in the shape of a famous person's handprint that also bears the famous person's name and picture in the palm of the hand. This innovative product is a personal way for fans to show their support for a celebrity, amateur, professional, athlete, character, or notable figure while also displaying an image of that individual. This item can additionally be offered in a collector's version similar to the original Fan Hand, displaying different pictures on each finger on the person's hand. For magnets involving athletes of sports in which footwork is key, such as a soccer player or a punter in football, the outline can consist of the player's foot with the same image and nameplate design. This product can give fans a personal interaction, such as comparing hand sizes or high-fiving, with their favorite famous person, as well as a way to mount and display admiration.

Fan Hand is interactive and personal method and memorabilia that fans can display around their homes to show their adoration for the famous people whom they admire. This unique product can comprise the real outline of a famous person's, athlete's, character's, or notable figure's hand. Inside of the hand, there can be a nameplate and a picture of the person. There can be a magnet as well as additional wall adhesive on the back of the hand that will allow the memorabilia to be placed around the house. The outline can also be offered in a foot shape for a variety of athletes who play sports involving their feet. The exact specification, materials used, and method of use of Fan Hand can vary upon manufacturing.

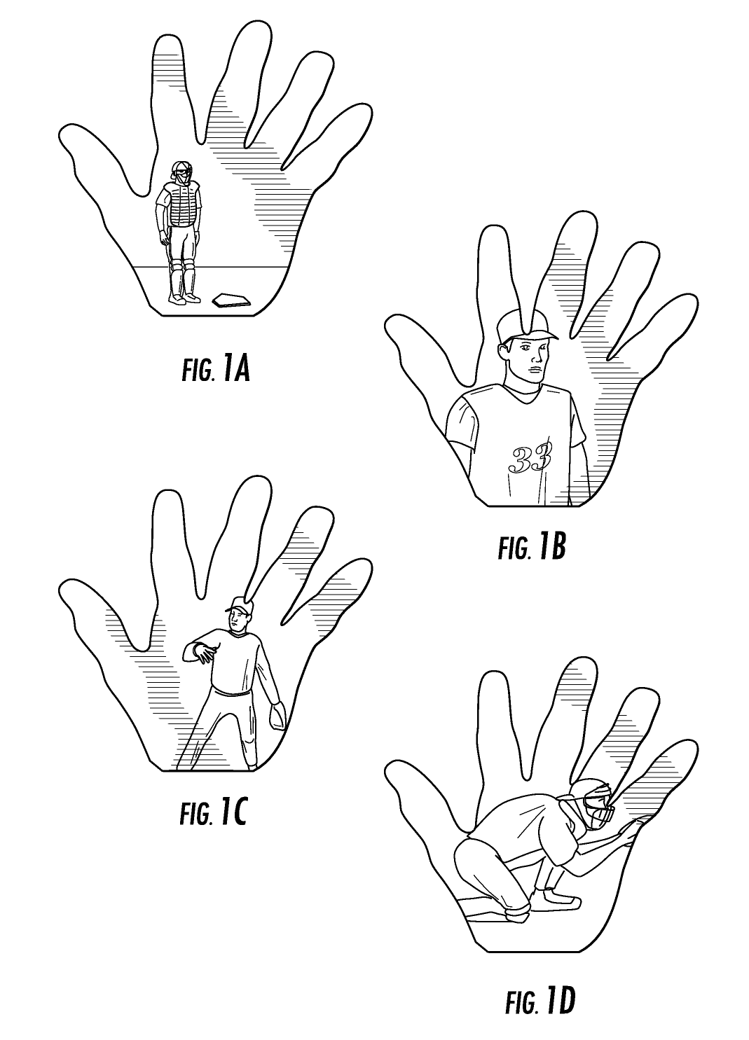

FIG. 1a illustrates a catcher behind the plate of a baseball diamond.

FIG. 1b illustrates a baseball player's torso and face.

FIG. 1c illustrates a baseball player in an action shot.

FIG. 1d illustrates a baseball catcher crouching to receive and incoming ball.

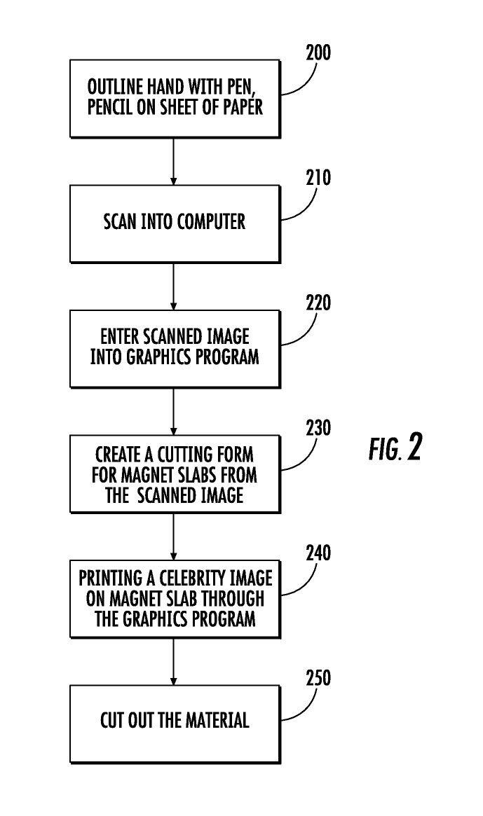

FIG. 2 illustrates the steps in the process of manufacturing the magnets of the instant embodiment. First an outline is made 200 with pen or pencil on a sheet of paper of the person's hand (or foot), (or made from a photograph) and then it is scanned into a computer 210 or downloaded thereto. Once the scanned image is entered into the computer, a user can enter the scanned image into a graphics program 220 for manipulation by a machine tool. If using a photograph, the graphics program is user manipulated to make an outline of the hand or foot for creation of the cutting form. This tool creates a cutting form 230 for the magnet slabs from the scanned image. In other words, the form will be used to press down upon each magnet or group of magnets together to slice off the excess magnetic material leaving the foot or hand as desired. A person's image is imprinted on the magnet slab(s) 240 through a printer attached to the computer and then the hand or foot is cut out 250 singly or in groups depending on the size and nature of the cutting form and press being utilized. Alternatives to the cutting through the use of form and machine tool is a box cutter or scissors though these would be slower implementations.

Finally, Fan Hand is unique and useful because fans can now compare hand sizes with their idol, give high fives with and to a Fan Hand, collect them for value, and would be great for autographs. Additionally, Fan Hand is a more personal way for the fans to relate to their favorite person. The invention has thus been described in such clear and precise terms as to enable one of ordinary skill in the art to understand its fundamental principles.

I claim:

1. A method of making a magnetic slab comprising the steps of:
placing a personal appendage on a background and outlining the personal appendage on the background.

2. The method of claim 1 further comprising the steps of:
scanning the outline into a computer.

3. The method of claim 2 further comprising the steps of:
entering a scanned image into a graphics program.

4. The method of claim 3 further comprising the steps of:
creating a cutting form from the scanned image.

5. The method of claim 4 further comprising the steps of:
printing an image on the magnetic slab.

6. The method of claim 5, further comprising the steps of:
cutting the magnetic slab using the cutting form.

7. The method of claim 1 wherein the personal appendage is a foot.

8. The method of claim 1 wherein the personal appendage is a hand.

9. A magnetic slab comprising:
a main portion shaped as a palm integrally connected to
a first portion of the slab shaped as a thumb; and the main portion also integrally connected to
a second portion of the slab shaped as an index finger.

10. The magnetic slab of claim 9 further comprising:
a third portion of the slab integrally connected to the main portion and shaped as a middle finger.

11. The magnetic slab of claim 10 further comprising:
a fourth portion of the slab integrally connected to the main portion and shaped as a ring finger.

12. The magnetic slab of claim 11 further comprising:
a fifth portion of the slab integrally connected to the main portion and shaped as a pinky.

13. The magnetic slab of claim 9 further comprising:
a scanned image imprinted on the magnetic slab.

14. A magnetic slab comprising:
a portion shaped as a hindfoot integrally connected with a second portion shaped as a midfoot.

15. The magnetic slab of claim 14, further comprising:
a third portion shaped as a forefoot integrally connected with the second portion.

16. The magnetic slab of claim 15, further comprising;
a plurality of other portions shaped as toes integrally connected to the forefoot portion.
